(19) United States
(12) Patent Application Publication
(10) Pub. No.: US 2024/0281257 A2
(43) Pub. Date: Aug. 22, 2024

(54) A Concept for Orchestration of Microservices

(71) Applicant: Intel Corporation, Santa Clara, CA (US)

(72) Inventors: Tat TAN, Bayan Lepas (MY); Kamarul ABDUL RASHID, Bayan Lepas (MY)

(21) Appl. No.: 18/307,171

(22) Filed: Apr. 26, 2023

(51) Int. Cl. G06F 9/44; G06F 11/30

(52) U.S. Cl. CPC G06F 9/44; G06F 11/302

(57) ABSTRACT

Various examples relate to apparatuses, devices, methods and computer programs for wrapping a monolithic application. In one aspect, such an apparatus is to observe a behavior of the monolithic application, and to provide a wrapper for wrapping the monolithic application, the wrapper comprising an interface that exposes one or more capabilities of the monolithic application to a microservice managing platform, with the interface being based on the observed behavior.

### BACKGROUND

Microservices have become the de-facto standard for cloud native development. The idea of dividing an application into an ensemble of services that are customer-facing, and developing them accordingly, has transformed the way developers and product owners think about what they are offering.

### BRIEF DESCRIPTION OF THE FIGURES

Some examples of apparatuses and/or methods will be described in the following by way of example only, and with reference to the accompanying figures, in which

FIG. 1a shows a schematic diagram of an example of an apparatus or device for a monolithic application, and of a computer system comprising such an apparatus or device;

FIG. 1b shows a schematic diagram of an example of executing a monolithic application in one or more wrappers;

FIGS. 1c, 1d and 1e show flow charts of examples of a method for a monolithic application;

FIGS. 2a and 2b show a schematic diagrams of examples of a monolithic and a microservices-based application;

FIG. 3 shows an example of a wrapper around a monolithic application; and

FIG. 4 shows a schematic diagram of an example of breaking a monolithic application into multiple instances to mimic microservices.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

Various examples of the present disclosure relate to a concept for microservices auto-wrappers for applications.

In modern cloud-native development patterns, an application may be broken into a set of loosely coupled, fine-grained services, using a lightweight protocol to communicate and exchange message. As a result, separate teams can own and deliver a microservice independent of other components (microservices) for an application. This translates into the ability of updating a microservice without having to update the entire application. In other words, a microservice becomes an application with its own roadmap or follow continuous delivery mechanism offering the most flexibility. Moreover, services for an application can be developed using different languages, allowing for best in class for each type of service. Services can be managed using a manageability framework such as Kubernetes, allowing for heterogenous scaling techniques based on demand on each microservice.

Many applications, including legacy systems available today and providing valuable services, do not follow the microservices principle. Moreover, refactoring all of these applications can be a lengthy and expensive exercise. Most engineering teams are hesitant to re-write an application by breaking it into microservices to follow this paradigm. This means that they cannot benefit from the advantages of microservices deployments such as manageability, scale, and reuse.

In the present disclosure, a wrapper is proposed that is wrapped around legacy applications to allow them to be deployed in a microservices environment. In various examples, monolithic applications are observed with the goal of providing recommendations on how to re-architect into microservices, providing efficient designs and architectures of the entire system.

A system is proposed that supports at least one of a watch mode and a recommend mode.

In the watch mode, the system observes an application and its behavior. It then creates a wrapper that can transform this application into a single microservice. This may be considered less than ideal, as it is keeping the application as one entity rather than breaking it into a set of microservices. However, using this method, the application can be brought in an environment with other microservices, which may be enough to support legacy applications without modifying them.

In the recommend mode, the system may propose how an application can be broken into a set of microservices based on observing messages in the application. For example, the application may support the observation by using a common protocol such gRPC (a popular Remote Procedure Call implementation), REST (Representational State Transfer), or any other communication protocol. If messages are passed between the different components without being exposed, then the recommender mode wouldn't work.

The proposed concept may be considered relevant for both cloud and edge deployments where microservices are growing in popularity. They can support the inclusion of legacy applications. In the recommend mode, the proposed concept may even propose an improved way to break an application into a set of microservices based on messages included. This may allow for the application to scale by potentially having some of its microservices deployed more than once to support the demand.

In short, the proposed system may wrap around legacy applications in a microservice environment. In addition, recommendations may be offered for automating the design of microservices.

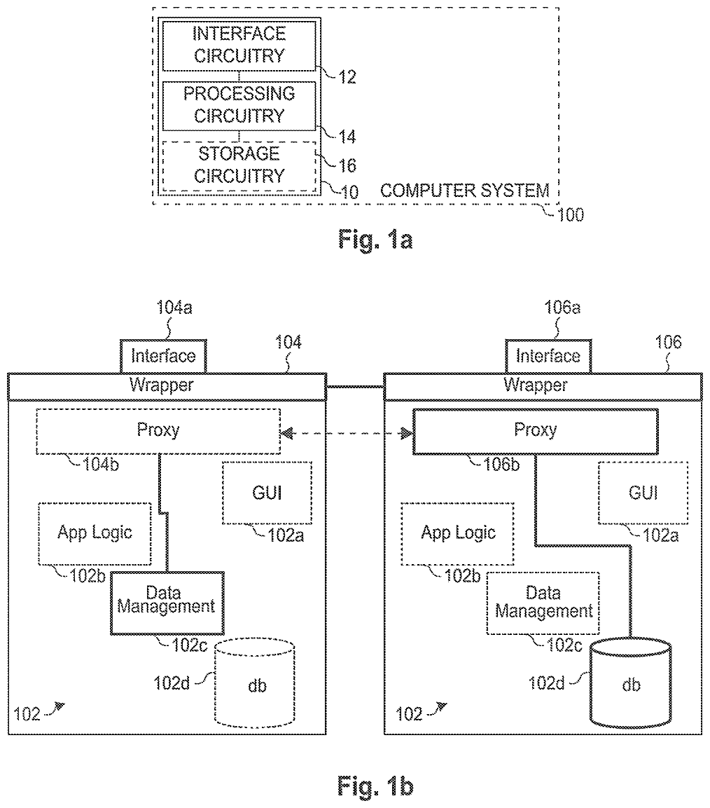

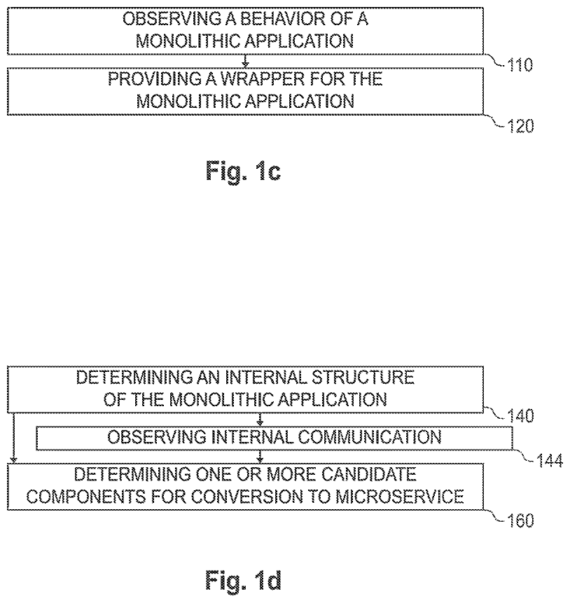

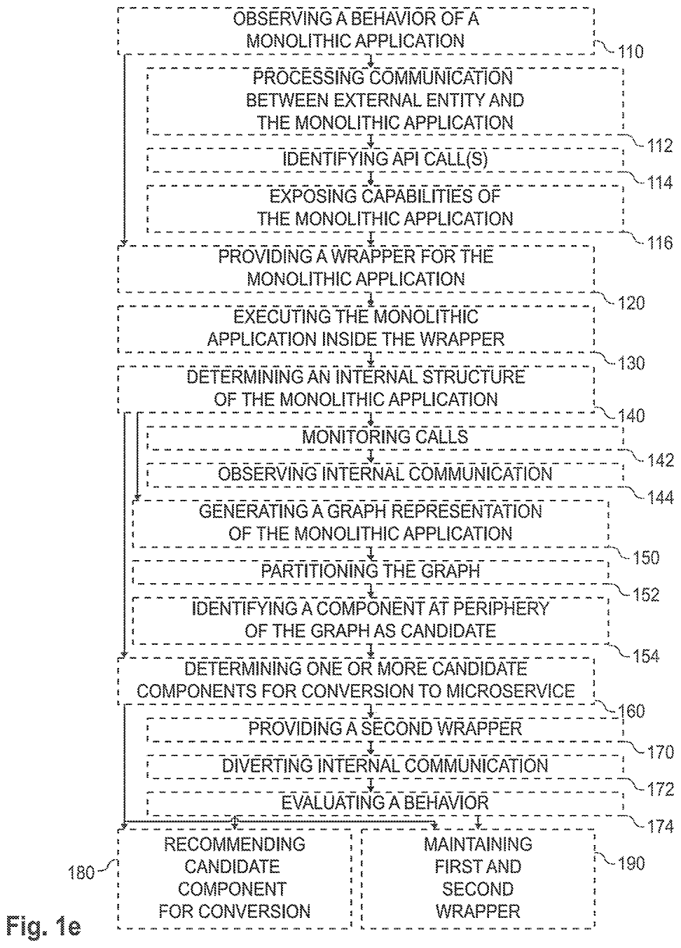

FIGS. 1a to 1e show a practical implementation of the proposed system. FIG. 1a shows a schematic diagram of an example of an apparatus 10 or device 10 for a monolithic application, and of a computer system 100 comprising such an apparatus or device 10. The apparatus 10 comprises circuitry to provide the functionality of the apparatus 10. For example, the circuitry of the apparatus 10 may be configured to provide the functionality of the apparatus 10. For example, the apparatus 10 of FIG. 1a comprises interface circuitry 12, processing circuitry 14 and (optional) storage circuitry 16. For example, the processing circuitry 14 may be coupled with the interface circuitry 12 and with the storage circuitry 16. For example, the processing circuitry 14 may provide the functionality of the apparatus, in conjunction with the interface circuitry 12 (for exchanging information, e.g., with other components inside or outside the computer system 100 comprising the apparatus or device 10) and the storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIG. 1a comprises means for processing 14, which may correspond to or be implemented by the processing circuitry 14, means for communicating 12, which may correspond to or be implemented by the interface circuitry 12, and (optional) means for storing information 16, which may correspond to or be implemented by the storage circuitry 16. In general, the functionality of the processing circuitry 14 or means for processing 14 may be implemented by the processing circuitry 14 or means for processing 14 executing machine-readable instructions. Accordingly, any feature ascribed to the processing circuitry 14 or means for processing 14 may be defined by one or more instructions of a plurality of machine-readable instructions. The apparatus 10 or device 10 may comprise the machine-readable instructions, e.g., within the storage circuitry 16 or means for storing information 16.

To illustrate the concept, FIG. 1b shows a schematic diagram of an example of executing a monolithic application 102 in one or more wrappers 104; 106. The Figure will be described in more detail in connection with the apparatus 10, device 10 and computer system 100 of FIG. 1a, and in connection with the methods of FIGS. 1c to 1e.

In a first configuration of the apparatus 10 or device 10, the processing circuitry 14 or means for processing 14 is to observe a behavior of the monolithic application 102 (shown in FIG. 1b), and to provide a wrapper 104 for wrapping the monolithic application, the wrapper comprising an interface 104a that exposes one or more capabilities of the monolithic application to a microservice managing platform (not shown), with the interface being based on the observed behavior. By providing the wrapper 104 with the interface 104a, the monolithic application 102 can be used, as is, as part of a microservice cluster, allowing use of the monolithic application as part of a larger system, with the conveniences regarding management known from microservice clusters. It may be likened to the “watch mode” mentioned above.

FIG. 1c shows a flow chart of an example of a corresponding method (i.e., corresponding to the first configuration) for the monolithic application. The method comprises observing 110 the behavior of the monolithic application 102. The method comprises providing 120 the wrapper 104 for wrapping the monolithic application, the wrapper comprising the interface 104a the one or more capabilities that exposes the one or more capabilities of the monolithic application to a microservice managing platform, with the interface being based on the observed behavior.

In a second configuration of the apparatus 10 or device 10, the processing circuitry 14 or means for processing 14 is to determine an internal structure of the monolithic application 102 to determine components 102a; 102b; 102c; 102d of the monolithic application, to observe an internal communication between the components of the monolithic application, and to determine one or more candidate components for converting a component of the monolithic application to a microservice based on the internal structure and based on the internal communication. The second configuration goes beyond the “watch mode” and actively takes steps to modularize the monolithic application into detachable components, to improve scalability of the application, as the different modular components can then be deployed on different computer systems and/or scaled by deploying some components multiple times. For example, the different components that are separate can then be provided by providing multiple wrappers with proxies between them, or some components can be replaced by “proper” microservices. It may be likened to the “recommend mode” mentioned above.

FIG. 1d shows a flow chart of an example of a corresponding method (i.e., corresponding to the second configuration) for the monolithic application. The method comprises determining 140 an internal structure of the monolithic application 102 to determine components 102a; 102b; 102c; 102d of the monolithic application. The method comprises observing 144 an internal communication between the components of the monolithic application. The method comprises determining 160 one or more candidate components for converting a component of the monolithic application to a microservice based on the internal structure and based on the internal communication.

In FIG. 1e, an example is given of potential operations performed by both methods is given, depending on which aspects of the handling of the monolithic applications are performed. With respect to the first and second configuration, many operations included in the method shown in FIG. 1e are optional. For example, the method or methods shown in FIGS. 1c, 1d and 1e may be performed by the computer system 100, e.g., by the apparatus 10 or device 10 of the computer system 100.

In the following, the features of the different configurations of the apparatus 10, the device 10, the respective methods and the computer system 100 are introduced in more detail with respect to the apparatus 10. Features introduced in connection with the apparatus 10 may likewise be included in the corresponding device 10, method(s) and computer system 100.

The present disclosure relate to a concept for handling a monolithic application, and in particular to a concept for integrating a monolithic application in a microservice cluster. Microservices are an architectural style used in software development that involves breaking down large, complex applications into smaller services that work together. Each microservice is independently deployable, maintainable, and upgradeable, and communicates with other services through APIs (Application Programming Interfaces). A microservice cluster is a group of microservices that work together to provide a specific functionality within an application. Each microservice in the cluster is specialized in a specific task, and the cluster as a whole provides a more complex and advanced set of features than what each individual microservice can achieve on its own. In other words, a microservice cluster is a collection of coordinated microservices that work together to perform a specific task, while microservices are independent, modular components of an application architecture of a microservice cluster. In contrast, monolithic applications are, as the name indicates, monolithic—at least when seen from the outside. A monolithic application is typically built as a single, self-contained unit with all of its components tightly coupled together. Building monolithic applications has, for a long time, been the predominant design philosophy, even for web applications or web services. Therefore, for continuity of service, or as a way to preserve legacy systems without much effort, the proposed concept provides two approaches for integrating such legacy monolithic applications in a microservice-based environment (i.e., the first configuration or “watch mode”), and for breaking monolithic applications apart (i.e., the second configuration or “recommend mode”), automatically or semiautomatically, to improve the scalability of the monolithic application.

In the following, the first configuration (i.e., the watch mode) will be introduced first, with the second configuration (i.e., the recommend mode) following behind. As will become evident, various aspects of the second configuration can build upon the wrapper technology introduced by the first configuration. However, most aspects are also usable without using the wrapper technology, and can in particular operate without providing the wrapper with an interface. Thus, the interface exposing the capabilities of the monolithic application to the microservice management platform (e.g., Kubernetes) may be regarded as optional with respect to the second configuration.

In the “watch mode”, the focus is on integrating an existing monolithic application, as is, into a microservice cluster. For this purpose, the communication of the monolithic application with other entities (i.e., entities outside the monolithic application) is of interest, as the entities outside the monolithic applications are the entities either controlling the monolithic applications, or using a service provided by the monolithic application. For this purpose, the behavior of the monolithic application is observed. For the purpose of the “watch mode”, observing the behavior of the monolithic application relates to the behavior of the monolithic application towards other entities, i.e., the one or more entities controlling the monolithic application or using a service provided by the monolithic application. In other words, in the context of the first configuration (i.e., the watch mode), the behavior of the monolithic application relates to the communication behavior of the monolithic application with at least one other (i.e., external) entity outside the monolithic application.

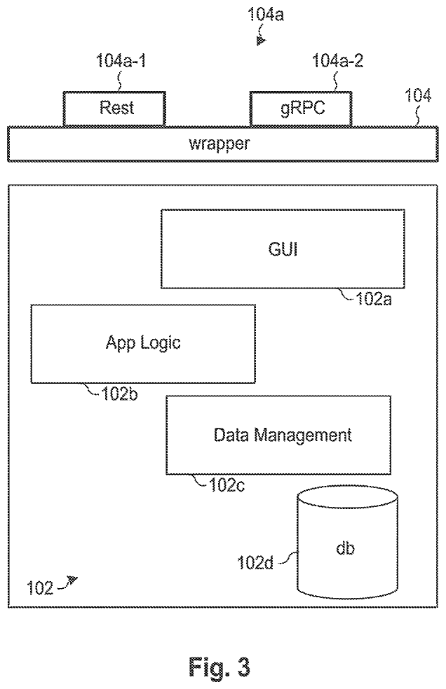

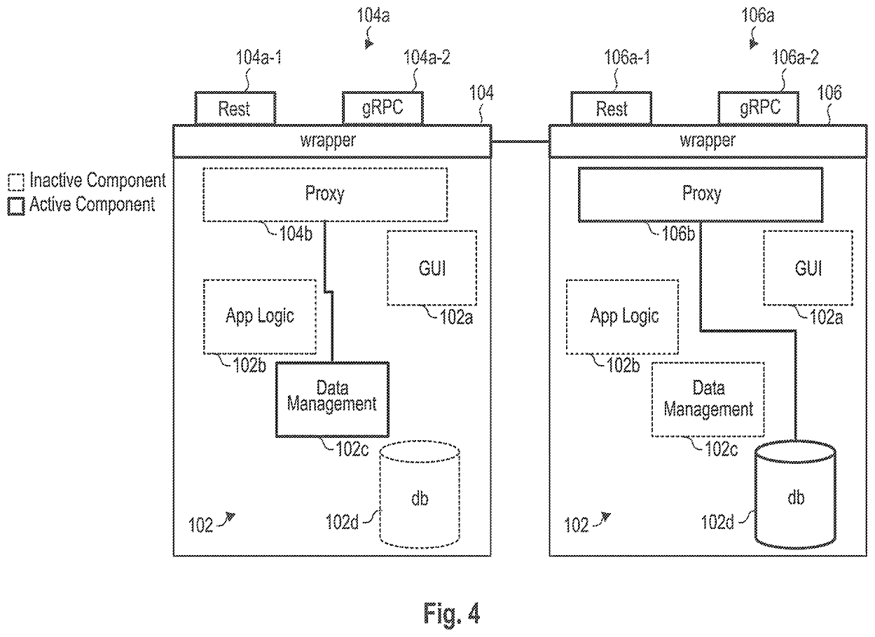

Therefore, the processing circuitry may observe the behavior of the monolithic behavior by processing a communication between at least one external entity and the monolithic application. Accordingly, as further shown in FIG. 1e, the method may comprise observing 110 the behavior of the monolithic behavior by processing 112 the communication between the at least one external entity and the monolithic application. For example, a traffic inspection proxy or traffic inspection gateway may be placed between the monolithic application and the at least one external entity, and the traffic routed between the monolithic application and the at least one external entity may be processed to process the communication between the at least one external entity and the monolithic application. In particular, within the communication, so-called calls, which are requests made by one piece of software to another piece of software (the monolithic application in the present case), may be detected and processed to determine the behavior of the monolithic application and in particular the one or more capabilities supported by the monolithic application. For example, the calls may be application programming interface (API) calls or Remote Procedure Calls (RPCs). For the sake of simplicity, RPCs are, in the following, treated as a special form of API call. The processing circuitry or means for processing may identify one or more application programming interface calls supported by the monolithic application within the communication. Accordingly, as further shown in FIG. 1e, the method may comprise identifying 114 the one or more application programming interface calls supported by the monolithic application within the communication. The processing circuitry may then expose the one or more capabilities of the monolithic application, as part of the wrapper interface 104, based on the one or more application programming interface calls supported by the monolithic application. Accordingly, as shown in FIG. 1e, the method may comprise exposing 116 the one or more capabilities of the monolithic application. For example, the one or more capabilities may be exposed using the same format as the monolithic application. Alternatively, as shown in FIGS. 3 and 4, for example, the one or more capabilities may be exposed, as API/RPC calls, via interfaces 104a-1, 104a-2 not supported by the monolithic application, e.g., via a Representational State Transfer (REST) API 104a-1 or via a RPC (e.g., gRPC) interface 104a-2. For example, the processing circuitry may include translation functionality in the interface, to translate between the API calls supported by the monolithic application and the API/RPC calls exposed via the interface of the wrapper.

The monolithic application can then be executed inside the wrapper 104, providing its service from inside the wrapper. In other words, the method may comprise executing 130 the monolithic application inside the wrapper. When the monolithic application is executed inside the wrapper, it can then be integrated into a microservice cluster, albeit as a single “microservice” (or rather a service), without the functionality being broken into a plurality of interrelated microservices. In effect, the wrapper makes the monolithic application appear, when executed, as a single microservice. To wrap the monolithic application, various techniques may be used. For example, the processing circuitry may include the application in a container, virtual machine or other environment generated by an isolation technique. A container is a lightweight and portable executable package that contains the necessary files and libraries to run an application or set of applications, e.g., to provide a microservice. Containers work by abstracting the underlying operating system and sharing the host's kernel. A virtual machine, on the other hand, is a software emulation of a physical computer system. It includes a virtual hardware platform, which runs an operating system and other software as if they were running on a physical computer. In both cases, the container or virtual machine may be combined with the aforementioned interface to build the wrapper (with respect to the first configuration). Thus, the wrapper 104 may be a combination of a container and an interface, of a virtual machine and an interface, or an encapsulation provided by another isolation technique, combined with an interface.

By providing the wrapper with the interface, and executing the monolithic application within the wrapper, the monolithic application can be integrated within an existing (or newly-created) microservice cluster (with the microservice managing platform controlling the monolithic application via the interface 104a of the wrapper 104, and, optionally, with other API also being made possible via the interface.

In the “recommend mode”, the focus is on scalability. The recommend mode tries to identify one or more candidate, among components of the monolithic application, that can be moved to a separate container, virtual machine, or wrapper, without loss of functionality. While, in the previous explanations, the monolithic application has been treated as being entirely monolithic, in reality, even monolithic applications include separate components. For example, as shown in FIGS. 1b, 2, 3 and 4, many (web) applications are built using distinct components, e.g., according to a development pattern such as the Model-View-Controller pattern. In practice, there are often separate components for presenting information (often via a web interface), a component for processing data, a component for storing and retrieving data, and a database. In FIGS. 1b, 2, 3 and 4, these components are shown as the GUI (Graphical User Interface) 102a, which is the component for presenting information, the App Logic 102b, which is the component for processing data, as Data Management 102c, which is the component for storing and retrieving data, and db 102d (database), which is the database that is being used to store the data. Thus, even monolithic applications often contain multiple components. However, these components are often tightly integrated. In the “recommend mode”, the aim is to identify one or more candidate components that can be moved to another microservice (e.g., a “real” microservice, or another instance of the monolithic application), to improve the scalability of the monolithic application within the microservice cluster.

As already outlined in connection with the “second configuration” and method of FIG. 1d, the processing circuitry may determine an internal structure of the monolithic application to determine components of the monolithic application, observe an internal communication between the components of the monolithic application, and determine one or more candidate components for converting a component of the monolithic application to a microservice based on the internal structure and based on the internal communication. In this context, converting the component to a microservice does not necessarily imply that the component is converted to an actual microservice or replaced by a microservice. In some cases, as will become clear in the following, the candidate component may be used, within a wrapper comprising the monolithic application, apart from other components of the monolithic application, by routing the communication between different wrapper comprising instances of the monolithic application.

To determine (e.g., process) the internal structure of the monolithic application, and thus determine components of the monolithic application, heuristics may be used. For example, the processing circuitry may use heuristics to scan the monolithic application for use of a known components, such as for use of a known database server, for use of a known application server, for use of a known web server or web proxy, for use of a known framework, for use of a known middleware, enabling the identification of the components. Based on this determination, in some cases, a straight-forward determination of a candidate component can be made, e.g., if the component is a component that is known to be easy to separate, such as a web proxy or a database. In some examples, the processing circuitry may determine the one or more candidate components based on the candidate component being known to be separable, e.g., based on the candidate component being a database component, a logging component, or a web proxy component.

Once the components of the monolithic application are determined, a proxy or gateway functionality may be inserted between the components (or in the network between the components), in order to observe (i.e., monitor) the communication between the components of the monolithic applications. This communication may, as is usual in applications comprising multiple components, often be made via calls between the different components of the monolithic application. Therefore, the processing circuitry may observe the internal communication between the components of the monolithic application by monitoring one or more calls made by one component of the monolithic application to another component of the monolithic application. Accordingly, as shown in FIG. 1e, the method may comprise observing 144 the internal communication between the components of the monolithic application by monitoring 142 the one or more calls made by one component of the monolithic application to another component of the monolithic application. While these calls might not include all of the communication between the components (in some cases, communication may be performed via a shared memory), such calls can at least be guided along different ways when tearing apart the monolithic application.

Within the observed communication, the content of the communication may be of less interest than the amount of the communication. In particular, the amount of communication can be used to judge whether the performance impact of tearing apart components is likely to be higher or lower. For example, the processing circuitry may determine the one or more candidate components based on the amount of communication between the candidate components and one or more other components of the monolithic application. For example, the higher the amount of communication between two components of the monolithic application, the more the performance may suffer when the two components are separated. For example, components with little or no communication between them can usually be separated with less performance impact than components with a large amount of communication between them. For example, heuristics may be used to determine the one or more candidate components based on the amount of communication between the candidate component and the one or more other components of the monolithic applications. Alternatively, or additionally, graph theory may be used to partition the components of the monolithic application, as will be shown in the following.

Graphs containing vertices and edges are a mathematical construct that can be used, for example, to represent relationships between different entities. If a graph is used this way, the entities are represented as the vertices (also called “nodes”) of the graph, and the relationships between the entities are represented as the edges of the graph. In the present context, a graph representation of the monolithic application may be constructed, with the vertices of the graph representing the components of the monolithic application, and the edges representing the communication (e.g., the amount of communication) between the components of the monolithic application. For example, the processing circuitry may generate a graph representation of the monolithic application, with the nodes of the graph representing the components of the monolithic application and the vertices of the graph representing the communication between the components of the monolithic application. Accordingly, as further shown in FIG. 1e, the method may comprise generating 150 the graph representation of the monolithic application. This graph representation (short “graph”) may now be used to determine the one or more candidate components, by partitioning the graph (such that each partition represents one resulting service, microservice or wrapper around components of the monolithic application). In other words, the processing circuitry may partition the graph to determine the one or more candidate components for converting a component of the monolithic application to a microservice based on the graph representation. Accordingly, as further shown in FIG. 1e, the method may comprise partitioning 152 the graph to determine the one or more candidate components for converting a component of the monolithic application to a microservice based on the graph representation. For example, the graph representation may be used to determine the one or more candidate components by clustering the components of the monolithic application based on the amount of communication between them, and partitioning the graph such, that each of the partitions includes one (or more) of the clusters of components of the monolithic application.

For example, based on the amount of communication among the different components, vertices of the graph may move closer together within a graphical representation of the graph representation, and thus towards a center of the graph representations. A component that remains are at the periphery of the graph may remain there due to a low amount of communication between the component and other components, which may make the component a candidate for conversion. Thus, the processing circuitry may identify at least one component that may be at a periphery of the graph as candidate. Accordingly, as shown in FIG. 1e, the method may comprise identifying 154 at least one component that may be at a periphery of the graph as candidate.

To perform the partitioning, graph partitioning algorithms may be used. In evaluation, machine-learning-based graph partitioning techniques have been shown to be suitable for performing the graph partitioning. Thus, the processing circuitry may use a machine learning technique such as Bayesian network to partition the graph.

Machine learning refers to algorithms and statistical models that computer systems may use to perform a specific task without using explicit instructions, instead relying on models and inference. For example, in machine-learning, instead of a rule-based transformation of data, a transformation of data may be used, that is inferred from an analysis of historical and/or training data. In various examples of the present disclosure, machine learning techniques that are based on a Bayesian network may be used. A Bayesian network is a type of machine learning that is based on a probabilistic directed acyclic graph. In particular, a Bayesian network may represent a set of random variables and their conditional dependencies using a directed acyclic graph. In the present case, instead of representing a set of random variables, the components of the monolithic application may be represented by the graph. Bayesian networks can be used for graph partitioning by modeling the relationships (e.g., the amount of traffic) between the vertices in the graph (i.e., the components of the monolithic application) as conditional probabilities. In this approach, the graph is divided into smaller sections such that the vertices within each section are highly correlated (e.g., according to the amount of traffic between the components), while the vertices between different sections are less correlated. To use a Bayesian network for graph partitioning, the Bayesian network may be constructed from the graph representation of the monolithic application by defining the relationship between the vertices in the graph. Once the Bayesian network is constructed, a variety of algorithms, such as Markov Chain Monte Carlo (MCMC) or Gibbs sampling, may be used to partition the graph.

In the previous examples, examples were given for identifying one or more candidate components for conversion to a microservice. While information on these one or more candidate components can be presented to an administrator of the monolithic application, in some examples, the suitability of the one or more candidate components for conversion may be tested practically. For this purpose, as shown in FIG. 1b, multiple instances (e.g., a first instance and a second instance) of the monolithic application 102 may be created and wrapped into two wrappers 104, 106. Thus, the wrapper 104 may be a first wrapper for wrapping a first instance (i.e., a first copy of the monolithic application being executed) of the monolithic application. In addition, a second wrapper 106 may be provided for wrapping a second instance (i.e., a second copy of the monolithic application being executed) of the monolithic application. Accordingly, as further shown in FIG. 1e, the method may comprise providing 170 the second wrapper 106 for wrapping a second instance of the monolithic application. For example, the first instance of the monolithic application may be cloned (e.g., by cloning a file-system snapshot) to create the second instance of the monolithic application, so both instances are, at the beginning, identical. Both wrapper may, for example, be provided with corresponding interfaces 104a, 104b. In addition, both wrappers may be provided a proxy 104b, 106b for communicating with the proxy 104a, 106b of the respective other instance. In other words, the instances may communicate through the proxies 104b, 106b included in the respective wrappers 104, 106. This additional communication channel can now be used to divert communication between the components of one instances towards the respective other instance. For example, as shown in FIG. 1b, through the proxies 104b, 106b, the Data Management component 102c of the first instance may communicate with the database 102d of the second instance. For example, the processing circuitry may divert internal communication directed to a candidate component of the first instance to a corresponding component of the second instance via the respective proxies, and evaluate the behavior of at least the first instance of the monolithic application while the internal communication is diverted. Accordingly, as further shown in FIG. 1e, the method comprise diverting 172 internal communication directed to a candidate component of the first instance to a corresponding component of the second instance via the respective proxies, and evaluating 174 the behavior of at least the first instance of the monolithic application while the internal communication may be diverted. In other words, instead of the communication occurring between the components of the same instance, at least some communication, e.g., between the components of the first instance and between the candidate component in the second instance, occurs via the respective proxies. To enforce communication via the proxies, in the first instance, the candidate component may be deactivated, while, in the second instance, the other components may be deactivated.

If the monolithic application still works (in a performant manner) in this setup, spread across multiple instances, the component being “moved” to the second instance may be deemed a suitable candidate for conversion to a microservice. To ascertain that the monolithic application still works in this manner, the output of the two-instance configuration may be compared to an output of a regular copy of the monolithic application (at identical inputs). In other words, the monolithic application may be executed once regularly (e.g., inside a single wrapper), and once split across two wrappers, and the output provided by both versions may be compared to evaluate the behavior of at least the first instance of the monolithic application, e.g., to confirm that the output of the first instance is the same as the output of the regular copy of the monolithic application. In other words, the processing circuitry may evaluate the behavior of at least the first instance of the monolithic application by comparing an output of at least the first instance of the monolithic application with a corresponding output of an unaltered copy of the monolithic application.

If the evaluation is positive, i.e., if the first instance behaves like the unaltered copy of the monolithic application, the candidate component may be recommended for conversion. For example, the processing circuitry may recommend the candidate component for conversion to a microservice if the behavior of at least the first instance may be as expected. Accordingly, as shown in FIG. 1e, the method may comprise recommending 180 the candidate component for conversion to a microservice if the behavior of at least the first instance may be as expected. For example, the processing circuitry may provide information on the candidate component (e.g., on the one or more candidate information) to an administrator of the monolithic application, e.g., as an electronic message, or via a dashboard. This may also be done if the evaluation via the two-wrapper configuration is not done.

Alternatively, or additionally, to recommending the candidate component for conversion, the two-wrapper setup may be maintained, effectively implementing the conversion of the monolithic application from one microservice into two (or even more) microservices. Accordingly, the processing circuitry may maintain the first wrapper and the second wrapper if the behavior of at least the first instance is as expected. Accordingly, the method may comprise maintaining 190 the first wrapper and the second wrapper if the behavior of at least the first instance is as expected. In this case, the monolithic application may subsequently be used in a configuration, where some functionality (implemented by the candidate component) is moved to the second instance (and deactivated or unused in the first instance).

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general-purpose processor, a Digital Signal Processor (DSP), a micro-controller, etc.

For example, the storage circuitry 16 or means for storing information 16 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the computer system 100 may be a server computer system, i.e., a computer system being used to serve functionality, such as the functionality provided by the computational device, or a workstation computer system 100.

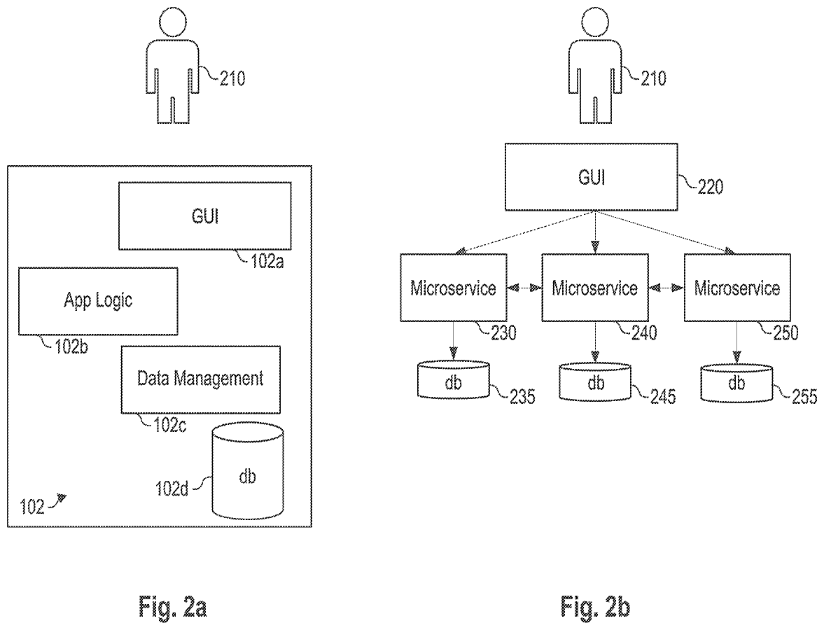

More details and aspects of the apparatus 10, the device 10, computer system 100, the method(s) and of one or more corresponding computer programs are mentioned in connection with the proposed concept or one or more examples described above or below (e.g., FIGS. 2a to 4). The apparatus 10, the device 10, computer system 100, the method(s) and corresponding computer programs may comprise one or more additional optional features corresponding to one or more aspects of the proposed concept, or one or more examples described above or below.

FIGS. 2a and 2b show schematic diagrams of examples of a monolithic and a microservices-based application. FIG. 2a shows an example of the monolithic application. In this example, the application has a GUI (Graphical User Interface), some logic that is implemented using libraries and SDKs (Software Development Kits), a data layer to make sure our data is well maintained and a database (db) to store the data. Scaling, deployment, and reuse are not easy to achieve. In FIG. 2b, it is demonstrated how such an application can be transformed to the microservices architecture. In this scenario, multiple microservices are used that correspond to different functions of the application. For example, one microservice can be used to plot data, while another one is used to allow the user to update certain types of data. If more plotting is needed, then the plotting microservice can be deployed on more powerful compute (i.e., physical or virtual compute resources) or compute that can accelerate such a function. While a legacy application cannot benefit from such deployment improvements, it is a high cognitive load to ask the developers to switch overnight to a microservices architecture.

The proposed concept starts by creating a wrapper around the application to allow it to be managed by a microservices framework. This may include watching its behavior and documenting the set of calls (API) that it can support. These can then be documented with the types of input to be used by a manageability framework if needed. The application is then added to a container which can be managed by Kubernetes. This is the Watch Mode.

FIG. 3 shows an example of a wrapper around a monolithic application. As shown in FIG. 3, the wrapper may include a REST interface and/or a gRPC interface. FIG. 3 shows a schematic diagram of an example of a resulting architecture. Now, a system like Kubernetes can manage the application. However, it is still a large monolithic application, with drawbacks regarding scaling.

In the Recommend Mode, the system may perform one or more of the following tasks. For example, the system may observe input and output messages to other applications (whether through the network or processes if on the same machine). The system may monitor data transfer happening between the different processes of the application. If the data transfers are encrypted, then the proposed system may not be able to know the logic or content. However, the proposed system may be able to observe the fact that there was a transfer. The system may also inspect for the presence of a database. A database is a valuable indicator that some data is being managed which is a great place to start to wrap into a microservice for reuse and scale.

The data collected above about the behavior of the application may then allow breaking the applications into its functions. For example, the system may add proxy code that is able to mimic the active participation of another function. FIG. 3 below shows an example of how this can be achieved. FIG. 4 shows a schematic diagram of an example of breaking a monolithic application into multiple instances to mimic microservices. In this example, the recommender can see that there is a module in the application that interfaces with the database, as the system is able to see data go in and out of a database binary. It uses this knowledge to test whether the two components (data management and database) can be broken into two application instances. It may run two copies of the applications, capturing the messages generated by Data Management, and sending them to the second instance running the database. The proposed Recommender Mode can run this in parallel to a regular instance of the entire application and compare the outcome of the 2 deployments. If they are the same, then this recommendation of breaking the functions does work. While this may not transform the application into a set of microservices, it does offer better scalability. Now, the system has determined that, if one database instance is not enough, or the compute resource cannot support the database, is may be possible to change the deployment for better scale. This determination is possible without modifying a single line of code.

For example, the recommender mode can be used to offer insights into the application to a developer so that they can best architect their code into a set of microservices. The proxy can collect information and telemetry on the load of messages needed and use that to offer recommendations for optimized performance on which components may or should be broken. For example, if the number of messages between a Function A and a Function B means that the message exchange load between 2 microservices is too expensive, then either the two functions should not be broken into separate microservices, or if they are broken, they may be deployed on the same physical machine.

The Recommender Mode can use AI (Artificial Intelligence)/ML (Machine-Learning) techniques such as collaborative learning to learn over time how to improve its recommendations and anticipate potential functions that are candidates for microservices.

The messaging complexity may be abstracted using the proxy. The proxy may cover (all) basic messaging techniques used in development such direct calls, gRPC, REST, MQTT (Message Queuing Telemetry Transport) etc. However, the proxy might not be built by a single developer (for all use cases). It may rather allow developer to create plugins that can be interchanged.

In the following, some examples of the proposed concept are presented:

An example (e.g., example 1) relates to an apparatus (10) for a monolithic application, the apparatus comprising interface circuitry (12), machine-readable instructions and processing circuitry (14) to execute the machine-readable instructions to observe a behavior of the monolithic application (102), and provide a wrapper (104) for wrapping the monolithic application, the wrapper comprising an interface (104a) that exposes one or more capabilities of the monolithic application to a microservice managing platform, with the interface being based on the observed behavior.

Another example (e.g., example 2) relates to a previously described example (e.g., example 1) or to any of the examples described herein, further comprising that the machine-readable instructions comprise instructions to execute the monolithic application inside the wrapper.

Another example (e.g., example 3) relates to a previously described example (e.g., one of the examples 1 to 2) or to any of the examples described herein, further comprising that the wrapper makes the monolithic application appear, when executed, as a single microservice.

Another example (e.g., example 4) relates to a previously described example (e.g., one of the examples 1 to 3) or to any of the examples described herein, further comprising that the machine-readable instructions comprise instructions to include the application in a container, virtual machine or other environment generated by an isolation technique.

Another example (e.g., example 5) relates to a previously described example (e.g., one of the examples 1 to 4) or to any of the examples described herein, further comprising that the machine-readable instructions comprise instructions to observe the behavior of the monolithic behavior by processing a communication between at least one external entity and the monolithic application.

Another example (e.g., example 6) relates to a previously described example (e.g., example 5) or to any of the examples described herein, further comprising that the machine-readable instructions comprise instructions to identify one or more application programming interface calls supported by the monolithic application within the communication, and to expose the one or more capabilities of the monolithic application based on the one or more application programming interface calls supported by the monolithic application.

Another example (e.g., example 7) relates to a previously described example (e.g., one of the examples 1 to 6) or to any of the examples described herein, further comprising that the machine-readable instructions comprise instructions to determine an internal structure of the monolithic application to determine components of the monolithic application, observe an internal communication between the components of the monolithic application, and determine one or more candidate components for converting a component of the monolithic application to a microservice based on the internal structure and based on the internal communication.

Another example (e.g., example 8) relates to a previously described example (e.g., example 7) or to any of the examples described herein, further comprising that the machine-readable instructions comprise instructions to observe the internal communication between the components of the monolithic application by monitoring one or more calls made by one component of the monolithic application to another component of the monolithic application.

Another example (e.g., example 9) relates to a previously described example (e.g., one of the examples 7 to 8) or to any of the examples described herein, further comprising that the machine-readable instructions comprise instructions to determine the one or more candidate components based on an amount of communication between the candidate components and one or more other components of the monolithic application.

Another example (e.g., example 10) relates to a previously described example (e.g., one of the examples 7 to 9) or to any of the examples described herein, further comprising that the machine-readable instructions comprise instructions to generate a graph representation of the monolithic application, with the nodes of the graph representing the components of the monolithic application and the vertices of the graph representing the communication between the components of the monolithic application, and to partition the graph to determine the one or more candidate components for converting a component of the monolithic application to a microservice based on the graph representation.

Another example (e.g., example 11) relates to a previously described example (e.g., example 10) or to any of the examples described herein, further comprising that the machine-readable instructions comprise instructions to use a machine learning technique such as Bayesian network to partition the graph.

Another example (e.g., example 12) relates to a previously described example (e.g., one of the examples 10 to 11) or to any of the examples described herein, further comprising that the machine-readable instructions comprise instructions to identify at least one component that is at a periphery of the graph as candidate.

Another example (e.g., example 13) relates to a previously described example (e.g., one of the examples 7 to 12) or to any of the examples described herein, further comprising that the wrapper (104) is a first wrapper for wrapping a first instance of the monolithic application, the machine-readable instructions comprising instructions to provide the first wrapper with a proxy (104b) for communicating with a proxy (106b) of a second wrapper (106) for wrapping a second instance of the monolithic application, instructions to divert internal communication directed to a candidate component of the first instance to a corresponding component of the second instance via the respective proxies, and instructions to evaluate the behavior of at least the first instance of the monolithic application while the internal communication is diverted.

Another example (e.g., example 14) relates to a previously described example (e.g., example 13) or to any of the examples described herein, further comprising that the machine-readable instructions comprise instructions to evaluate the behavior of at least the first instance of the monolithic application by comparing an output of at least the first instance of the monolithic application with a corresponding output of an unaltered copy of the monolithic application.

Another example (e.g., example 15) relates to a previously described example (e.g., one of the examples 13 to 14) or to any of the examples described herein, further comprising that the machine-readable instructions comprise instructions to recommend the candidate component for conversion to a microservice if the behavior of at least the first instance is as expected.

Another example (e.g., example 16) relates to a previously described example (e.g., one of the examples 13 to 15) or to any of the examples described herein, further comprising that the machine-readable instructions comprise instructions to maintain the first wrapper and the second wrapper if the behavior of at least the first instance is as expected.

An example (e.g., example 17) relates to an apparatus (10) for a monolithic application, the apparatus comprising interface circuitry (12), machine-readable instructions and processing circuitry (14) to execute the machine-readable instructions to determine an internal structure of the monolithic application (102) to determine components (102a-102d) of the monolithic application, observe an internal communication between the components of the monolithic application, and determine one or more candidate components for converting a component of the monolithic application to a microservice based on the internal structure and based on the internal communication.

Another example (e.g., example 18) relates to a previously described example (e.g., example 17) or to any of the examples described herein, further comprising that the machine-readable instructions comprise instructions to determine the one or more candidate components based on an amount of communication between the candidate components and one or more other components of the monolithic application.

Another example (e.g., example 19) relates to a previously described example (e.g., one of the examples 17 to 18) or to any of the examples described herein, further comprising that the machine-readable instructions comprise instructions to determine the one or more candidate components based on the candidate component being a database component.

Another example (e.g., example 20) relates to a previously described example (e.g., one of the examples 17 to 19) or to any of the examples described herein, further comprising that the machine-readable instructions comprise instructions to generate a graph representation of the monolithic application, with the nodes of the graph representing the components of the monolithic application and the vertices of the graph representing the communication between the components of the monolithic application, and to partition the graph to determine the one or more candidate components for converting a component of the monolithic application to a microservice based on the graph representation.

Another example (e.g., example 21) relates to a previously described example (e.g., example 20) or to any of the examples described herein, further comprising that the machine-readable instructions comprise instructions to use a machine-learning technique, such as a Bayesian network to partition the graph.

Another example (e.g., example 22) relates to a previously described example (e.g., one of the examples 20 to 21) or to any of the examples described herein, further comprising that the machine-readable instructions comprise instructions to identify at least one component that is at a periphery of the graph as candidate.

Another example (e.g., example 23) relates to a previously described example (e.g., one of the examples 17 to 22) or to any of the examples described herein, further comprising that the machine-readable instructions comprise instructions to provide a first wrapper (104) for wrapping a first instance of the monolithic application, the wrapper comprising a proxy (104b) for communicating with a proxy (106b) of a second wrapper (106) for wrapping a second instance of the monolithic application, instructions to divert internal communication directed to a candidate component of the first instance to a corresponding component of the second instance via the respective proxies, and instructions to evaluate the behavior of at least the first instance of the monolithic application while the internal communication is diverted.

Another example (e.g., example 24) relates to a previously described example (e.g., example 23) or to any of the examples described herein, further comprising that the machine-readable instructions comprise instructions to evaluate the behavior of at least the first instance of the monolithic application by comparing an output of at least the first instance of the monolithic application with a corresponding output of an unaltered copy of the monolithic application.

Another example (e.g., example 25) relates to a previously described example (e.g., one of the examples 23 to 24) or to any of the examples described herein, further comprising that the machine-readable instructions comprise instructions to recommend the candidate component for conversion to a microservice if the behavior of at least the first instance is as expected.

Another example (e.g., example 26) relates to a previously described example (e.g., one of the examples 23 to 25) or to any of the examples described herein, further comprising that the machine-readable instructions comprise instructions to maintain the first wrapper and the second wrapper if the behavior of at least the first instance is as expected.

An example (e.g., example 27) relates to an apparatus (10) for a monolithic application, the apparatus comprising processing circuitry (14) configured to observe a behavior of the monolithic application, and provide a wrapper for wrapping the monolithic application, the wrapper comprising an interface that exposes one or more capabilities of the monolithic application to a microservice managing platform, with the interface being based on the observed behavior.

An example (e.g., example 28) relates to an apparatus (10) for a monolithic application, the apparatus comprising processing circuitry (14) configured to determine an internal structure of the monolithic application to determine components of the monolithic application, observe an internal communication between the components of the monolithic application, and determine one or more candidate components for converting a component of the monolithic application to a microservice based on the internal structure and based on the internal communication.

An example (e.g., example 29) relates to a device (10) for a monolithic application, the device comprising means for processing (14) for observing a behavior of the monolithic application, and providing a wrapper for wrapping the monolithic application, the wrapper comprising an interface that exposes one or more capabilities of the monolithic application to a microservice managing platform, with the interface being based on the observed behavior.

An example (e.g., example 30) relates to a device (10) for a monolithic application, the device comprising means for processing (14) for determining an internal structure of the monolithic application to determine components of the monolithic application, observing an internal communication between the components of the monolithic application, and determining one or more candidate components for converting a component of the monolithic application to a microservice based on the internal structure and based on the internal communication.

An example (e.g., example 31) relates to a computer system (100) comprising the apparatus (10) or device (10) according to one of the examples 1 to 16, 27 or 29 (or according to any other example).

An example (e.g., example 32) relates to a computer system (100) comprising the apparatus (10) or device (10) according to one of the examples 17 to 26, 28 or 30 (or according to any other example).

An example (e.g., example 33) relates to a method for a monolithic application, the method comprising observing (110) a behavior of the monolithic application (102), and providing (120) a wrapper (104) for wrapping the monolithic application, the wrapper comprising an interface (104a) that exposes one or more capabilities of the monolithic application to a microservice managing platform, with the interface being based on the observed behavior.

Another example (e.g., example 34) relates to a previously described example (e.g., example 33) or to any of the examples described herein, further comprising that the method comprises executing (130) the monolithic application inside the wrapper.

Another example (e.g., example 35) relates to a previously described example (e.g., one of the examples 33 to 34) or to any of the examples described herein, further comprising that the wrapper makes the monolithic application appear, when executed, as a single microservice.

Another example (e.g., example 36) relates to a previously described example (e.g., one of the examples 33 to 35) or to any of the examples described herein, further comprising that the application is included in a container, virtual machine or other environment generated by an isolation technique.

Another example (e.g., example 37) relates to a previously described example (e.g., one of the examples 33 to 36) or to any of the examples described herein, further comprising that the method comprises observing (110) the behavior of the monolithic behavior by processing (112) a communication between at least one external entity and the monolithic application.

Another example (e.g., example 38) relates to a previously described example (e.g., example 37) or to any of the examples described herein, further comprising that the method comprises identifying (114) one or more application programming interface calls supported by the monolithic application within the communication, and exposing (116) the one or more capabilities of the monolithic application based on the one or more application programming interface calls supported by the monolithic application.

Another example (e.g., example 39) relates to a previously described example (e.g., one of the examples 33 to 38) or to any of the examples described herein, further comprising that the method comprises determining (140) an internal structure of the monolithic application to determine components of the monolithic application, observing (144) an internal communication between the components of the monolithic application, and determining (160) one or more candidate components for converting a component of the monolithic application to a microservice based on the internal structure and based on the internal communication.

Another example (e.g., example 40) relates to a previously described example (e.g., example 39) or to any of the examples described herein, further comprising that the method comprises observing (144) the internal communication between the components of the monolithic application by monitoring (142) one or more calls made by one component of the monolithic application to another component of the monolithic application.

Another example (e.g., example 41) relates to a previously described example (e.g., one of the examples 39 to 40) or to any of the examples described herein, further comprising that the method comprises determining (160) the one or more candidate components based on an amount of communication between the candidate components and one or more other components of the monolithic application.

Another example (e.g., example 42) relates to a previously described example (e.g., one of the examples 39 to 41) or to any of the examples described herein, further comprising that the method comprises generating (150) a graph representation of the monolithic application, with the nodes of the graph representing the components of the monolithic application and the vertices of the graph representing the communication between the components of the monolithic application, and partitioning (152) the graph to determine the one or more candidate components for converting a component of the monolithic application to a microservice based on the graph representation.

Another example (e.g., example 43) relates to a previously described example (e.g., example 42) or to any of the examples described herein, further comprising that the method comprises using a machine learning technique such as Bayesian network to partition of the graph.

Another example (e.g., example 44) relates to a previously described example (e.g., one of the examples 42 to 43) or to any of the examples described herein, further comprising that the method comprises identifying (154) at least one component that is at a periphery of the graph as candidate.

Another example (e.g., example 45) relates to a previously described example (e.g., one of the examples 39 to 44) or to any of the examples described herein, further comprising that the wrapper (104) is a first wrapper for wrapping a first instance of the monolithic application, wherein the method comprises providing (120) the first wrapper with a proxy (104b) for communicating with a proxy (106b) of a second wrapper (106) for wrapping a second instance of the monolithic application, diverting (172) internal communication directed to a candidate component of the first instance to a corresponding component of the second instance via the respective proxies, and evaluating (174) the behavior of at least the first instance of the monolithic application while the internal communication is diverted.

Another example (e.g., example 46) relates to a previously described example (e.g., example 45) or to any of the examples described herein, further comprising that the method comprises evaluating (174) the behavior of at least the first instance of the monolithic application by comparing an output of at least the first instance of the monolithic application with a corresponding output of an unaltered copy of the monolithic application.

Another example (e.g., example 47) relates to a previously described example (e.g., one of the examples 45 to 46) or to any of the examples described herein, further comprising that the method comprises recommending (180) the candidate component for conversion to a microservice if the behavior of at least the first instance is as expected.

Another example (e.g., example 48) relates to a previously described example (e.g., one of the examples 45 to 47) or to any of the examples described herein, further comprising that the method comprises maintaining (190) the first wrapper and the second wrapper if the behavior of at least the first instance is as expected.

An example (e.g., example 49) relates to a method for a monolithic application, the method comprising determining (140) an internal structure of the monolithic application (102) to determine components (102a-102d) of the monolithic application, observing (144) an internal communication between the components of the monolithic application, and determining (160) one or more candidate components for converting a component of the monolithic application to a microservice based on the internal structure and based on the internal communication.

Another example (e.g., example 50) relates to a previously described example (e.g., example 49) or to any of the examples described herein, further comprising that the method comprises determining (160) the one or more candidate components based on an amount of communication between the candidate components and one or more other components of the monolithic application.

Another example (e.g., example 51) relates to a previously described example (e.g., one of the examples 49 to 50) or to any of the examples described herein, further comprising that the method comprises determining (160) the one or more candidate components based on the candidate component being a database component.

Another example (e.g., example 52) relates to a previously described example (e.g., one of the examples 49 to 51) or to any of the examples described herein, further comprising that the method comprises generating (150) a graph representation of the monolithic application, with the nodes of the graph representing the components of the monolithic application and the vertices of the graph representing the communication between the components of the monolithic application, and partitioning (152) the graph to determine the one or more candidate components for converting a component of the monolithic application to a microservice based on the graph representation.

Another example (e.g., example 53) relates to a previously described example (e.g., example 52) or to any of the examples described herein, further comprising that the method comprises using a machine-learning technique, such as a Bayesian network to partition (152) the graph.

Another example (e.g., example 54) relates to a previously described example (e.g., one of the examples 52 to 53) or to any of the examples described herein, further comprising that the method comprises identifying (154) at least one component that is at a periphery of the graph as candidate.

Another example (e.g., example 55) relates to a previously described example (e.g., one of the examples 49 to 54) or to any of the examples described herein, further comprising that the method comprises providing (120) a first wrapper (104) for wrapping a first instance of the monolithic application, the wrapper comprising a proxy (104b) for communicating with a proxy (106b) of a second wrapper (106) for wrapping a second instance of the monolithic application, diverting (172) internal communication directed to a candidate component of the first instance to a corresponding component of the second instance via the respective proxies, and evaluating (174) the behavior of at least the first instance of the monolithic application while the internal communication is diverted.

Another example (e.g., example 56) relates to a previously described example (e.g., example 55) or to any of the examples described herein, further comprising that the method comprises evaluating (174) the behavior of at least the first instance of the monolithic application by comparing an output of at least the first instance of the monolithic application with a corresponding output of an unaltered copy of the monolithic application.

Another example (e.g., example 57) relates to a previously described example (e.g., one of the examples 55 to 56) or to any of the examples described herein, further comprising that the method comprises recommending (180) the candidate component for conversion to a microservice if the behavior of at least the first instance is as expected.

Another example (e.g., example 58) relates to a previously described example (e.g., one of the examples 55 to 57) or to any of the examples described herein, further comprising that the method comprises maintaining (190) the first wrapper and the second wrapper if the behavior of at least the first instance is as expected.

An example (e.g., example 59) relates to a computer system (100) being configured to perform the method according to one of the examples 33 to 48 (or according to any other example).

An example (e.g., example 60) relates to a computer system (100) being configured to perform the method according to one of the examples 49 to 58 (or according to any other example).

An example (e.g., example 61) relates to a non-transitory machine-readable storage medium including program code, when executed, to cause a machine to perform the method of one of the examples 33 to 48 (or according to any other example) or the method of one of the examples 49 to 58 (or according to any other example).

An example (e.g., example 62) relates to a computer program having a program code for performing the method of one of the examples the method of one of the examples 33 to 48 (or according to any other example) or the method of one of the examples 49 to 58 (or according to any other example) when the computer program is executed on a computer, a processor, or a programmable hardware component.

An example (e.g., example 63) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for a monolithic application, the apparatus comprising interface circuitry, machine-readable instructions and processing circuitry to execute the machine-readable instructions to:
observe a behavior of the monolithic application, and
provide a wrapper for wrapping the monolithic application, the wrapper comprising an interface that exposes one or more capabilities of the monolithic application to a microservice managing platform, with the interface being based on the observed behavior.

2. The apparatus according to claim 1, wherein the machine-readable instructions comprise instructions to execute the monolithic application inside the wrapper.

3. The apparatus according to claim 1, wherein the wrapper makes the monolithic application appear, when executed, as a single microservice.

4. The apparatus according to claim 1, wherein the machine-readable instructions comprise instructions to include the application in a container, virtual machine or other environment generated by an isolation technique.

5. The apparatus according to claim 1, wherein the machine-readable instructions comprise instructions to observe the behavior of the monolithic behavior by processing a communication between at least one external entity and the monolithic application.

6. The apparatus according to claim 5, wherein the machine-readable instructions comprise instructions to identify one or more application programming interface calls supported by the monolithic application within the communication, and to expose the one or more capabilities of the monolithic application based on the one or more application programming interface calls supported by the monolithic application.

7. The apparatus according to claim 1, wherein the machine-readable instructions comprise instructions to determine an internal structure of the monolithic application to determine components of the monolithic application, observe an internal communication between the components of the monolithic application, and determine one or more candidate components for converting a component of the monolithic application to a microservice based on the internal structure and based on the internal communication.

8. The apparatus according to claim 7, wherein the machine-readable instructions comprise instructions to observe the internal communication between the components of the monolithic application by monitoring one or more calls made by one component of the monolithic application to another component of the monolithic application.

9. The apparatus according to claim 7, wherein the machine-readable instructions comprise instructions to determine the one or more candidate components based on an amount of communication between the candidate components and one or more other components of the monolithic application.

10. The apparatus according to claim 7, wherein the machine-readable instructions comprise instructions to generate a graph representation of the monolithic application, with the nodes of the graph representing the components of the monolithic application and the vertices of the graph representing the communication between the components of the monolithic application, and to partition the graph to determine the one or more candidate components for converting a component of the monolithic application to a microservice based on the graph representation.

11. The apparatus according to claim 10, wherein the machine-readable instructions comprise instructions to use a machine learning technique such as Bayesian network to partition the graph.

12. The apparatus according to claim 10, wherein the machine-readable instructions comprise instructions to identify at least one component that is at a periphery of the graph as candidate.

13. The apparatus according to claim 7, wherein the wrapper is a first wrapper for wrapping a first instance of the monolithic application, the machine-readable instructions comprising instructions to provide the first wrapper with a proxy for communicating with a proxy of a second wrapper for wrapping a second instance of the monolithic application, instructions to divert internal communication directed to a candidate component of the first instance to a corresponding component of the second instance via the respective proxies, and instructions to evaluate the behavior of at least the first instance of the monolithic application while the internal communication is diverted.

14. The apparatus according to claim 13, wherein the machine-readable instructions comprise instructions to evaluate the behavior of at least the first instance of the monolithic application by comparing an output of at least the first instance of the monolithic application with a corresponding output of an unaltered copy of the monolithic application.

15. The apparatus according to claim 13, wherein the machine-readable instructions comprise instructions to recommend the candidate component for conversion to a microservice if the behavior of at least the first instance is as expected.

16. The apparatus according to claim 13, wherein the machine-readable instructions comprise instructions to maintain the first wrapper and the second wrapper if the behavior of at least the first instance is as expected.

17. An apparatus for a monolithic application, the apparatus comprising interface circuitry, machine-readable instructions and processing circuitry to execute the machine-readable instructions to:
determine an internal structure of the monolithic application to determine components of the monolithic application,
observe an internal communication between the components of the monolithic application, and
determine one or more candidate components for converting a component of the monolithic application to a microservice based on the internal structure and based on the internal communication.

18. The apparatus according to claim 17, wherein the machine-readable instructions comprise instructions to determine the one or more candidate components based on an amount of communication between the candidate components and one or more other components of the monolithic application.

19. The apparatus according to claim 17, wherein the machine-readable instructions comprise instructions to determine the one or more candidate components based on the candidate component being a database component.

20. The apparatus according to claim 17, wherein the machine-readable instructions comprise instructions to generate a graph representation of the monolithic application, with the nodes of the graph representing the components of the monolithic application and the vertices of the graph representing the communication between the components of the monolithic application, and to partition the graph to determine the one or more candidate components for converting a component of the monolithic application to a microservice based on the graph representation.

21. The apparatus according to claim 17, wherein the machine-readable instructions comprise instructions to provide a first wrapper for wrapping a first instance of the monolithic application, the wrapper comprising a proxy for communicating with a proxy of a second wrapper for wrapping a second instance of the monolithic application, instructions to divert internal communication directed to a candidate component of the first instance to a corresponding component of the second instance via the respective proxies, and instructions to evaluate the behavior of at least the first instance of the monolithic application while the internal communication is diverted.

22. A method for a monolithic application, the method comprising:
observing a behavior of the monolithic application, and
providing a wrapper for wrapping the monolithic application, the wrapper comprising an interface that exposes one or more capabilities of the monolithic application to a microservice managing platform, with the interface being based on the observed behavior.

23. A method for a monolithic application, the method comprising:
determining an internal structure of the monolithic application to determine components of the monolithic application,
observing an internal communication between the components of the monolithic application, and
determining one or more candidate components for converting a component of the monolithic application to a microservice based on the internal structure and based on the internal communication.

24. A non-transitory machine-readable storage medium including program code, when executed, to cause a machine to perform the method of claim 22.

25. A non-transitory machine-readable storage medium including program code, when executed, to cause a machine to perform the method of claim 23.
